(19) United States
(12) Patent Application Publication
(10) Pub. No.: US 2009/0064531 A1
(43) Pub. Date: Mar. 12, 2009

(54) Cloth treating apparatus

(75) Inventors: Jung Wook Moon, Changwon-si (KR); Dae Yun Park, Changwon-si (KR); Sog Kie Hong, Changwon-si (KR); Jong Seok Kim, Changwon-si (KR); Seung Gyu Ryu, Changwon-si (KR); Hye Yong Park, Changwon-si (KR); Chang Gyu Choi, Changwon-si (KR); Dong Won Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/222,066

(22) Filed: Jul. 31, 2008

(30) Foreign Application Priority Data
Aug. 3, 2007 (KR) 10-2007-0078118

(51) Int. Cl. F26B 3/02; F26B 25/06; D06F 58/10; G05D 23/00

(52) U.S. Cl. 34/491; 34/218; 68/5 C; 700/299

(57) ABSTRACT

A cloth treating apparatus and a method of controlling the same are disclosed. A cloth treating apparatus includes a cabinet comprising an accommodating space which accommodates laundry, a air supplying device which supplies hot air to the accommodating space, a control unit that determines dryness of the laundry based on at least two temperatures of the cabinet to control the air supplying device. A method of controlling a cloth treating apparatus includes supplying hot air to an accommodating space of the cloth treating apparatus, measuring temperatures of at least two portions of the cloth treating apparatus, and determining dryness based on the measured at least two temperatures.

This application claims the benefit of the Patent Korean Application No. 10-2007-0078118, filed on Aug. 3, 2007, which is hereby incorporated by reference as if fully set forth herein.

### BACKGROUND OF THE INVENTION

1. Field of the Invention

The present invention relates to a cloth treating apparatus and a method of controlling the same. More particularly, the present invention relates to a cloth treating apparatus and a method of controlling the same, which is capable of sensing dryness of clothes automatically in case of drying clothes.

2. Discussion of the Related Art

Generally, cloth treating apparatuses may include washers, dryers and laundry devices having a drying and washing function. Recently, due to the enhanced standard of living, refreshers that refresh clothes, cloth items and beddings (hereinafter, laundry) have been under development. Here, a refresher refreshes laundry by dry or hot air that is supplied to the laundry held therein.

In a cloth treating apparatus such as the refresher, hot air is supplied to refresh the laundry held therein, by extension, to remove a water element. In case of supplying such the hot air, there may be a problem that dryness of laundry may not be sensed automatically.

### SUMMARY OF THE INVENTION

Accordingly, the present invention is directed to a cloth treating apparatus and a method of controlling a cloth treating apparatus.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a cloth treating apparatus includes a cabinet comprising an accommodating space which accommodates laundry; a air supplying device which supplies hot air to the accommodating space; a control unit that determines dryness of the laundry based on at least two temperatures of the cabinet to control the air supplying device.

The cloth treating apparatus may further include at least two sensors which measure the temperatures of the cabinet, respectively.

The control unit may determine the dryness of the laundry based on a temperature difference measured at the sensors to control the air supplying device.

The cloth treating apparatus may further include a steam generation unit that heats air to supply steam to the accommodating space.

The sensors may include a first sensor which measures a temperature of air drawn into the accommodating space; and a second sensor which measures a temperature of air discharged from the accommodating space.

The air supplying device may be configured of a heat pump including an evaporator, a compressor, a condenser and an expansion valve.

The cloth treating apparatus may further include a circulation duct which supplies hot air to an accommodating space, wherein the heat pump is provided along the circulation duct.

The first sensor may be positioned in the rear of the condenser along the circulation duct and the second sensor is positioned at a front end portion of the evaporator.

The control unit may determine the dryness of the laundry based on a temperature difference measured by the first and second sensor to control the air supplying device.

The control unit may determine the dryness of the laundry based on the temperature difference measured by the first and second sensor in a predetermined time period after the air supplying device is put into operation.

The control unit may determine that the dryness is substantially higher as the measured temperature difference is substantially smaller.

The control unit may control the air supplying device to be stopped if the measured temperature difference is below a standard temperature difference.

In another aspect, a method of controlling a cloth treating apparatus includes supplying hot air to an accommodating space of the cloth treating apparatus; measuring temperatures of at least two portions of the cloth treating apparatus; and determining dryness based on the measured at least two temperatures.

In the determination of the dryness, the dryness may be determined based on a difference of the at least two temperatures.

In the measurement of the temperatures of the at least two portions, a first temperature of air drawn into the accommodating space and a second temperature of air discharged from the accommodating space may be measured.

The measurement of the temperatures may start in a predetermined time period after the supply of the hot air to the accommodating space starts.

In the determination of the dryness based on the measured at least two temperatures, the dryness may be determined based on a difference between the first temperature and the second temperature.

The dryness may be substantially higher as the difference between the first and second temperature is substantially smaller.

The method may further include stopping the supplying of the hot air to the cloth treating apparatus if the difference between the first and second temperature is below a standard temperature difference.

The method of claim may further include spraying steam to an inside of the cloth treating apparatus, prior to the supplying of the hot air to the accommodating space.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a is a front view illustrating a cloth treating apparatus according to an exemplary embodiment;

FIG. 2 is a perspective view schematically illustrating an inside of a mechanism compartment shown in FIG. 1;

FIG. 3 is a graph illustrating a temperature change that is measured by a temperature sensor; and

FIG. 4 is a flow chart illustrating a method of controlling a cloth treating apparatus according to an exemplary embodiment.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

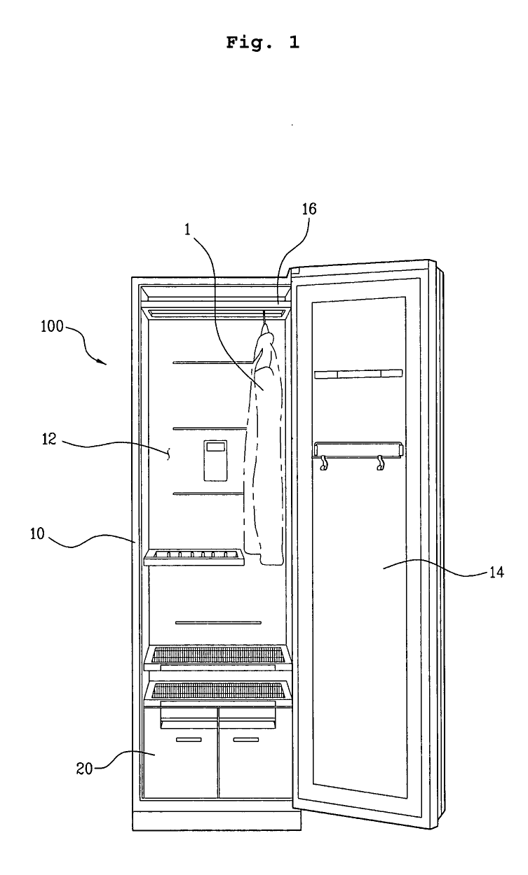

FIG. 1 is a front view illustrating a cloth treating apparatus according to an exemplary embodiment. This specification embodies a refresher that refreshes and supplies hot air to laundry as a cloth treating apparatus and it is not limited thereto. The concept of the specification may be applicable to the other kinds of cloth treating apparatuses including a heat pump that will be described later. Next, a configuration of the cloth treating apparatus will be described and a method of controlling the same will be described.

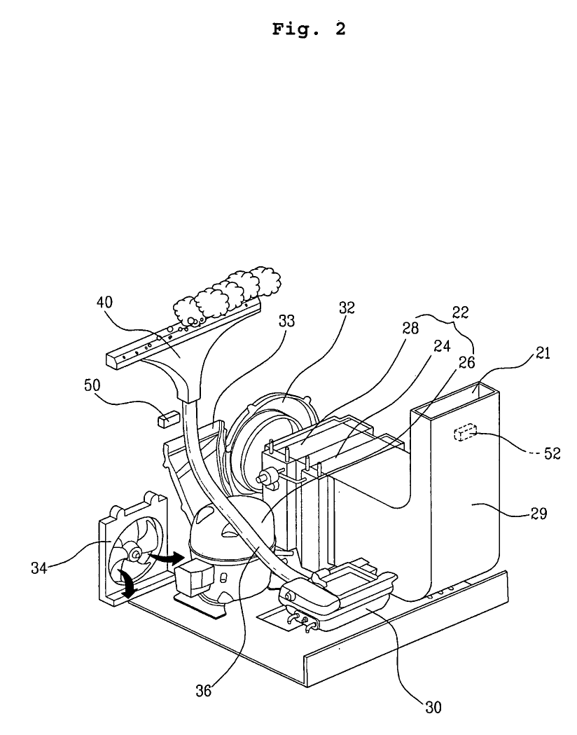

In reference to FIG. 1, a cloth treating apparatus 100 according to the embodiment includes a cabinet 10 having an accommodating space 12 for accommodating laundry 1, a air supplying device (22, see FIG. 2), at least two sensors (40 and 42, see FIG. 2) and a control unit (not shown). The air supplying device 22 supplies hot air to the accommodating space 12. The sensors 40 and 42 sense temperatures of the cabinet 10, respectively. The control unit (not shown) determines dryness of laundry based on the difference of the sensed temperatures to control the air supplying device 22. Furthermore, the cloth treating apparatus 100 may include a moisture supplying device (30, see FIG. 2) that selectively supplies moisture into the accommodating space 12.

Various kinds of elements which will be described later are provided in the cabinet 10 and the accommodating space 12 is formed in the cabinet 10 to accommodate the laundry. Such the accommodating space 12 is selectively in communication with an outside via a door 14. Various kinds of supporters 16 may be provided in the accommodating space 12 for the laundry 1 to be hung on. This supporting configuration is well-known in the art to which the specification pertains and thus the detailed description of the configuration will be omitted.

There may be formed in the cabinet 10 a mechanism compartment 20 that accommodates the air supplying device 22 and the moisture supplying device 30 to selectively supply hot air and moisture to the accommodating space 12. The mechanism compartment 20 may be positioned under the accommodating space 12. The air supplying device 22 and the moisture supplying device 30 are placed in the mechanism compartment 20. Since the hot air and the steam supplied to the accommodating space 12 has an ascensional property, it is preferred that the mechanism compartment 20 is positioned in a lower portion of the cabinet 10 to supply the hot air and the steam upward.

FIG. 2 is a perspective view schematically illustrating a configuration of the mechanism compartment 20. FIG. 2 shows only elements of a heat pump 22 and the moisture supplying device 30 for convenience sake and a drain line for connecting the elements with each other is not shown in FIG. 2.

In reference to FIG. 2, the heat pump 22 may be provided in the mechanism compartment 20 as the air supplying device for supplying hot air to the accommodating space (12, see FIG. 1) and the moisture supplying device 30.

The heat pump 22 employed as the air supplying device is similar to a heat pump that is commonly used in an air conditioner and variations of it. That is, the heat pump 22 includes an evaporator 24, a compressor 26, a condenser 28 and an expansion valve (not shown) which refrigerant is circulated through. Using this configuration, air is dehumidified and heated. Specifically, a latent heat of ambient air is absorbed, with the refrigerant being evaporated and the air is cooled enough to condense and remove the moisture of the air. In addition, if the refrigerant passes through the compressor 26 and it is condensed at the condenser 28, the latent heat is emitted toward the ambient air and the ambient air is heated. As a result, the evaporator 24 and the condenser 28 are functioned as a heat exchanger, such that the air drawn into the mechanism compartment 20 is dehumidified and heated through the evaporator 24 and the condenser 28 and that the dehumidified and heated air is supplied to the accommodating space 12.

The air heated by the heat pump 22 has a relatively low temperature, compared with the air heated by a conventional heater. However, the air is dehumidified without using any dehumidifier. As a result, the air re-supplied to the accommodating space 12 by the heat pump 22 may be relatively ‘low temperature dry air’ (here, the expression ‘low temperature’ means heated air having a relatively lower temperature than conventional heated air, not substantially low temperature air). The air supplied by the heat pump 22 according to the embodiment has a low temperature, compared with the hot air of the conventional cloth treating apparatus, but it may be dehumidified without any dehumidifier. Accordingly, this embodiment makes it possible to dry and refresh the laundry efficiently with a simple structure.

More specifically, an air inlet 21 is formed at an upper front side of the mechanism compartment 20 such that air inside the accommodating space 12 is drawn into the mechanism compartment 20 there through. A duct 29 that connects the air inlet 21, the evaporator 24, the condenser 28 and a fan 32 each other may form a path for the air to flow along. The air drawn into the mechanism compartment 20 through the air inlet 21 is dehumidified and heated, passing the heat pump 22. The dehumidified/heated air is re-supplied to the accommodating space 12 by the fan 32.

Here, although not shown in the drawings, it is preferred that a filter is provided at the air inlet 21. If the filter is provided at the air inlet 21, foreign substances that might be contained in the air drawn into the mechanism compartment 20 may be filtered and only clean air may be supplied to the accommodating space 12.

On the other hand, the moisture supplying device 30 may be provided in the accommodating space 12 to selectively supply moisture to the accommodating space 12. Preferably, the moisture supplying device comprises a steam generating device for generating and supplying steam into the accommodating space 12. As the steam is supplied to the accommodating space 12 by the steam generation unit 30, wrinkles and the like that might be generated on the laundry may be removed, by extension, the laundry may be sterilized by the steam or fabric refreshing of the laundry may rise. As a result, because of the steam, effects of sterilization and refresh may be obtained as well as the effect of wrinkle removal. A timing of steam spray may be adjustable and it is preferred that the steam is sprayed prior to the supply of the hot air performed by the heat pump 22. It is preferred that the hot air is supplied to dry the laundry after the high temperature steam is sprayed.

The steam generation unit 30 includes a heater (not shown) for heating water such that steam is generated. The steam is supplied to the accommodating space 12. An external water tap may be used as a water source for supplying water to the steam generation unit 30. Alternatively, a container-type water source may be provided in the mechanism compartment 20. It is preferred that the container-type water source is separable such that a user may separate the water source from the mechanism compartment 20 to fill up the water and that the user may install the water source again. In addition, the steam generated at the steam generation unit 30 is supplied to the accommodating space 12 through a steam hose 36 and a steam nozzle 40. In this case, it is preferred that a length of the steam hose 36 is shorter as possible to prevent the temperature of the steam from falling or being condensed during the steam flow. If the mechanism compartment 20 is positioned under the accommodating space 12, the steam nozzle 40 may be provided in a top of the mechanism compartment 20, that is, the steam may be supplied through a bottom of the accommodating space 12.

A circulation fan 34 may be provided at a rear side of the mechanism compartment 20. external air is supplied to an inside of the mechanism compartment 20 through the circulation fan 34 such that an temperature inside the mechanism compartment 20 is prevented from rising too much when the heat pump 22 and the steam generation unit 30 are put into operation.

However, if the hot air is supplied to perform a drying function in the cloth treating apparatus having the above configuration, there is no way in the conventional art to automatically determine dryness of laundry. According to the conventional art, if the laundry is dried by the supply of the hot air, the drying is performed during a predetermined time period, or a user opens the door (14, see FIG. 1) to determine the dryness manually and to control an operation of the cloth treating apparatus.

However, according to the conventional controlling method of supplying the hot air during the predetermined time period, the drying is performed according to the time. As a result, when the drying is finished, the laundry may not be dried completely or the laundry may be dried too much only to damage the fabric of the laundry. In addition, the conventional method of determining dryness has bad accuracy and it is inconvenient and it takes quite a time that the user should determine the dryness manually.

Accordingly, demands for a method of controlling a cloth treating apparatus capable of determining dryness of laundry automatically during the drying have been increasing.

To satisfy the demands, the laundry treating apparatus (100, see FIG. 1) includes the controller (not shown) to determine dryness of laundry by using information of at least two temperatures of the cabinet (10, see FIG. 1).

Specifically, the cloth treating apparatus may include at least two sensors 50 and 52 to measure the temperatures inside the cabinet 10. Here, the sensor may be configured of a first sensor 50 and a second sensor 52. The first sensor measures a temperature of air that is supplied to the accommodating space (12, see FIG. 1) of the cabinet 10 and the second sensor 52 measures a temperature of air that is supplied to the mechanism compartment 20 from the accommodating space 12 of the cabinet 10.

The first sensor 50 measures the temperature of the air supplied to the accommodating space 12. Specifically, if the heat pump 22 is adapted as the air supplying device, the first sensor 50 may be positioned in the rear of the condenser 28 of the heat pump 22. The air is heated at the condenser 28 and supplied to the accommodating space 12 by the fan 32. If the first sensor 51 senses the temperature of the air in the rear of the condenser 28, the temperature of the air supplied to the accommodating space 12 may be measured. Although it seems in FIG. 2 that the first sensor 50 is adjacent to an air outlet 33, the position of the first sensor 50 may be any portions to sense the temperature of the air supplied to the accommodating space 1, that is, any portions in the rear of the condenser 28. It is preferred that the first sensor 50 is installed in the right rear of the condenser 28 to measure the air heated at the condenser 28 right away.

The second sensor 52 measures the temperature of the air supplied to the mechanism compartment 20 from the accommodating space 12. Specifically, if the heat pump 22 is adapted as the air supplying device, the second sensor 52 may be positioned at a front end portion of the evaporator 24 of the heat pump 22. The air drawn into the mechanism compartment 20 passes the heat pump 22 through the evaporator 24. Thus, if the temperature of the air is measured at the front end portion of the evaporator 24 along the inside of the circulation duct 29 for forming the path of the air, it is possible to measure the temperature of the air discharged from the accommodating space 12.

For the second sensor 52 to measure the temperature of the air discharged from the accommodating space 12, it is preferred that the second sensor 52 is positioned close to the air inlet 21 of the mechanism compartment 20. If the second sensor 52 is positioned close to the air inlet 21, it is possible to measure the temperature of the air drawn into the air inlet 21.

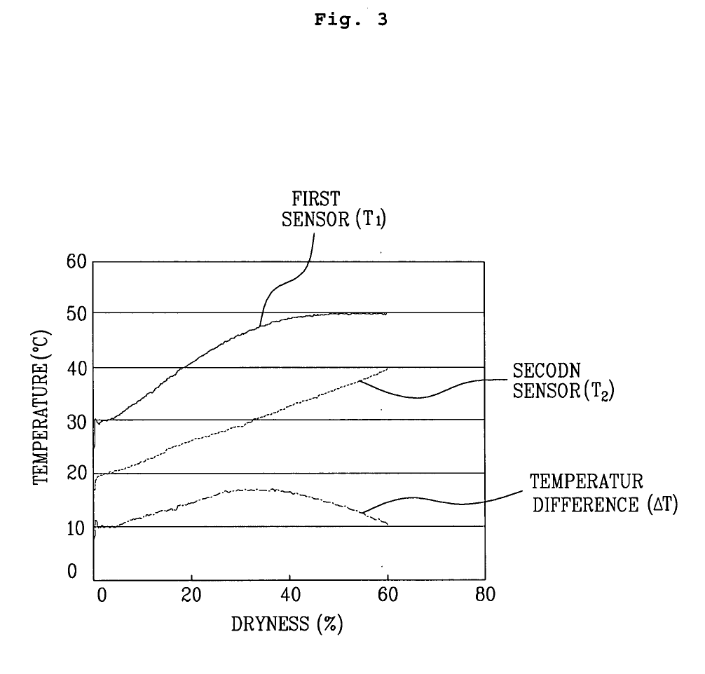

In the meantime, the control unit (not shown) automatically determines dryness of laundry according to the temperature difference measured by the first and second sensor 50 and 52 to control the operation of the heat pump 22. Next, in reference to FIG. 3, a method of determining the dryness according to the temperature difference of the first and second sensor 50 and 52 will be described.

FIG. 3 is a graph illustrating temperature differences measured by the first and second sensor 50 and 52.

In reference to FIG. 3, a first temperature (T1) measured at the first sensor 50, a second temperature (T2) measured at the second sensor 52 and a temperature difference (ΔT) may be shown. A vertical axis of the graph indicates a temperature (° C.) and a horizontal axis indicates dryness (%) according to the time elapsed. 0% of the dryness indicates that the drying is not performed at all in a primary period of the operation and 100% of the dryness indicates that the drying is complete in a predetermined time period and that the water element is all removed.

As shown in FIG. 3, as T1 is 30° C. and T2 is 20° C. in the primary period of the operation of the cloth treating apparatus, ΔT is 10° C. That is, the air drawn into the heat pump 22 is heated at the condenser 28 and the heated air is supplied to the accommodating space 1, the temperature difference measured at the first and second sensor 50 and 52 is approximately 10° C.

Hence, if the heat pump 22 is operated continuously as the time elapsed, there is a change in the temperature difference. If the laundry contains a water element a lot, the air supplied to the accommodating space 12 absorbs the water element of the laundry and it is drawn into the heat pump 22 of the mechanism compartment 20. Once the air having much moisture is drawn into the heat pump 22, much of the refrigerant is evaporated to condense the water element of the air and much latent heat is contained in the refrigerant. That is, the amount of the latent heat contained in the refrigerant evaporated at the evaporator 24 is increasing.

If the air is heated with the refrigerant containing the much latent heat flowing to the condenser 28 and being condensed, the much latent heat is emitted to heat the air. As a result, the air is heated at a high temperature, compared with heating the air containing less moisture. If the dryness of the laundry is low due to the much moisture contained in the laundry accommodated in the accommodating space 12, the temperature of the air heated at the condenser 28 is rising. As a result, the temperature difference (ΔT) measured at the first and second sensor 50 and 52 is increasing. This is confirmed by a rising curvature of the temperature difference (ΔT) as the time elapsed in FIG. 3.

In case that the moisture contained in the laundry is reduced as the drying is processed, that is, the dryness of the laundry is increasing, the temperature of the air heated at the condenser 20 is decreasing.

Specifically, as the amount of the moisture contained in the air drawn into the heat pump 22 is reducing, the amount of the latent heat contained in the refrigerant evaporated at the evaporator 24 is reducing. As a result, the amount of the latent heat emitted after being condensed at the condenser 28 is reducing to lower the temperature of the air heated at the condenser 29. This is confirmed by the descending curvature of the temperature difference (ΔT) if the dryness is over approximately 40%.

Accordingly, the control unit may determine the dryness of the laundry based on the temperature difference (ΔT) measured at the first and second sensor 50 and 52.

That is, it is possible to determine that the dryness is higher as the temperature difference is smaller. According to this embodiment, a preset standard temperature difference is inputted at the control unit and the measured temperature difference (ΔT) is compared with the standard temperature difference to determine the dryness. For example, if the standard temperature difference is preset as 10° C., the control unit compares the measured temperature difference (ΔT) with the standard temperature difference of 10° C. Hence, if the measured temperature difference (ΔT) is lower than the standard temperature difference, it is determined that the drying is complete and the operation of the air supplying device is stopped and the drying is complete.

The above standard temperature difference may be varied by the user. For example, if the user presets the standard temperature difference as 10° C., the dryness shown in FIG. 3 is corresponding to approximately 60%. If the user presets the standard temperature difference as 5° C., the dryness shown in FIG. 3 is corresponding to 70%. The user may adjust the dryness of the laundry by controlling the standard temperature difference properly.

If the dryness is determined based on the temperature difference (ΔT) measured by the first and second sensor 50 and 52, it is preferred that the temperature difference (ΔT) is compared with the standard temperature difference after a predetermined time period in the primary operation period. As shown in FIG. 3, the temperature difference (ΔT) is increasing until the middle operation period from the primary operation period and the temperature difference (ΔT) is decreasing after the middle operation period.

If the measured temperature difference (ΔT) is compared with the standard temperature difference even from the primary operation period, the air supplying device might be stopped in the primary operation period even when the drying is not complete. Here, it is preferred that the control unit compares the measured temperature difference (ΔT) with the standard temperature difference in a predetermined time period after the heat pump 22 is put into operation, for example, in at least 10 to 20 minutes.

Next, a method of controlling the cloth treating apparatus having the above configuration in reference to corresponding drawing.

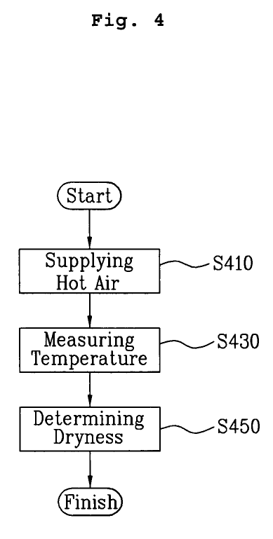

FIG. 4 is a flow chart illustrating the method according to an exemplary embodiment.

In reference to FIG. 4, the method of controlling the cloth treating apparatus includes supplying hot air (S410), measuring a temperature of the cloth treating apparatus (430) and determining dryness based on the measured temperature information (S450).

Firstly, once the cloth treating apparatus is operated, the control unit operates the air supplying device to supply low temperature dry air to the accommodating space (S410).

Hence, in a predetermined time period, for example, approximately 10 to 20 minutes after the air supplying device is put into operation, a temperature difference between the air supplied to the accommodating space 12 and the air discharged from the accommodating space 12 is measured by the first and second sensor 50 and 52 (S430).

The control unit compares the above measured temperature difference with a preset standard temperature difference (S450). In this case, if the measured temperature difference is higher than the standard temperature difference, it means that a wished dryness is not obtained and the hot air is supplied continuously. If the measured temperature difference is lower than the standard temperature difference, it means that the wished dryness is obtained and the operation of the heat pump 22 is stopped.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A cloth treating apparatus comprising:
a cabinet comprising an accommodating space which accommodates laundry;
a air supplying device which supplies hot air to the accommodating space;
a control unit that determines dryness of the laundry based on at least two temperatures of the cabinet to control the air supplying device.

2. The cloth treating apparatus of claim 1, further comprising:
at least two sensors which measure the temperatures of the cabinet, respectively.

3. The cloth treating apparatus of claim 2, wherein the control unit determines the dryness of the laundry based on a temperature difference measured at the sensors to control the air supplying device.

4. The cloth treating apparatus of claim 3, further comprising a moisture supplying device to supply the moisture to the accommodating space.

5. The cloth treating apparatus of claim 4, wherein the moisture supplying device comprises a steam generating device to generate steam and supply steam to the accommodating space.

6. The cloth treating apparatus of claim 3, wherein the sensors comprise,
a first sensor which measures a temperature of air drawn into the accommodating space; and
a second sensor which measures a temperature of air discharged from the accommodating space.

7. The cloth treating apparatus of claim 6, wherein the air supplying device comprises of a heat pump including an evaporator, a compressor, a condenser and an expansion valve.

8. The cloth treating apparatus of claim 7, further comprising a circulation duct to supply hot air to the accommodating space, wherein the heat pump is provided along the circulation duct.

9. The cloth treating apparatus of claim 8, wherein the first sensor is positioned in the rear of the condenser along the circulation duct and the second sensor is positioned at a front end portion of the evaporator.

10. The cloth treating apparatus of claim 6, wherein the control unit determines the dryness of the laundry based on a temperature difference measured by the first and second sensor to control the air supplying device.

11. The cloth treating apparatus of claim 10, wherein the control unit determines the dryness of the laundry based on the temperature difference measured by the first and second sensor in a predetermined time period after the air supplying device is put into operation.

12. The cloth treating apparatus of claim 10, wherein the control unit determines that the dryness is substantially higher as the measured temperature difference is substantially smaller.

13. The cloth treating apparatus of claim 12, wherein the control unit controls the air supplying device to be stopped if the measured temperature difference is below a standard temperature difference.

14. A method of controlling a cloth treating apparatus comprising:
supplying hot air to an accommodating space of the cloth treating apparatus;
measuring temperatures of at least two portions of the cloth treating apparatus; and
determining dryness based on the measured at least two temperatures.

15. The method of claim 14, wherein in the determination of the dryness, the dryness is determined based on a difference of the at least two temperatures.

16. The method of claim 14, wherein in the measurement of the temperatures of the at least two portions, a first temperature of air drawn into the accommodating space and a second temperature of air discharged from the accommodating space are measured.

17. The method of claim 16, wherein the measurement of the temperatures starts in a predetermined time period after the supply of the hot air to the accommodating space starts

18. The method of claim 16, wherein in the determination of the dryness based on the measured at least two temperatures, the dryness is determined based on a difference between the first temperature and the second temperature.

19. The method of claim 18, wherein the dryness is substantially higher as the difference between the first and second temperature is substantially smaller.

20. The method of claim 19, further comprising:
stopping the supplying of the hot air to the cloth treating apparatus if the difference between the first and second temperature is below the standard temperature difference.

21. The method of claim 14, further comprising:
spraying steam to an inside of the cloth treating apparatus, prior to the supplying of the hot air to the accommodating space.
